(19) United States
(12) Patent Application Publication
(10) Pub. No.: US 2011/0109900 A1
(43) Pub. Date: May 12, 2011

(54) Target apparatus utilizing laser light to actuated target advancement with a supportive backing allowing targets of inexpensive or recycled roll paper

(75) Inventor: Edward Lee McMillan, III, Pfafftown, NC (US)

(73) Assignee: Edward Lee McMillan, III, Pfafftown, NC (US)

(21) Appl. No.: 12/924,661

(22) Filed: Oct. 2, 2010

Related U.S. Application Data
(60) Provisional application No. 61/248,351, filed on Oct. 2, 2009.

(51) Int. Cl. G01J 1/42; F41G 3/26

(52) U.S. Cl. 356/227; 434/21

(57) ABSTRACT

Shooters have to presently take their firearms out of their hands to then actuate the advancement of a new target into shooting position. This unit will allow the shooter to shine his laser sight, infrared light, flashlight, or multi-spectrum light onto a sensor forwarding the next target into position without removing the firearm from its' shooting position. The unit also uses a unique target backing material that does not require targets to be made of rolls of coated or heavy material stock. The system can utilize rolls of cash register paper, cut sections of gift wrapping paper, or even paper towels as target materials without snagging and preventing the next target from being presented. The backing has stand-offs at 45 degree angles to the target material so that the target material rebounds against it upon impact.

### CROSS-REFERENCE TO RELATED APPLICATIONS

US Patent References:

| | | |
|---|---|---|
| Shooting Target Apparatus | Nasuti | 273/403 |
| Multifunctional Portable Target Stand | Wiser | |
| And Dispenser | | |
| Portable Target Holder | Hand | |
| Firearm Laser Training System and | Kendir | 434/21 |
| Method Employing Various Targets | | |
| To Simulate Training Scenarios | | |
| Target Practice Laser Transmitting/ | Akano | 463/49 |
| Receiving System, Target Practice | | |
| Laser Transmitter, and Target Practice | | |
| Laser Receiver | | |
| Network-Linked Laser Target Firearm | Shechter/Rosa | 434/21 |

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

Shooters having to remove their firearms from shooting positions to remotely advance the next target into shooting position and having to use rolls of heavy or specially coated expensive papers as target materials. Shooters have to presently take their firearms out of their hands to then actuate the advancement of a new target into shooting position. This unit will allow the shooter to shine his laser sight, infrared light, flashlight, or multi-spectrum light onto a sensor forwarding the next target into position without removing the firearm from its' shooting position. The unit also uses a unique target backing material that does not require targets to be made of rolls of coated or heavy material stock. The system can utilize rolls of cash register paper, cut sections of gift wrapping paper, or even paper towels as target materials without snagging and preventing the next target from being presented. The backing has stand-offs at 45 degree angles to the target material so that the target material rebounds against it upon impact. If portions of the target material should tear and extend into the backing material, the advancement motor will pull the material and it will ride up the 45 degree angled standoffs and clear itself of snags.

### BRIEF SUMMARY OF THE INVENTION

The present invention solves several issues related to firearm and related projectile practice, competition, and training issues. The laser displays advantages over the present art. Manual replacement of targets requires the shooter to move downrange in a position in front of the muzzle of the firearm, both theirs and others. The radio solution requires multiple frequencies and complex transmitter/receiver combinations with the requirement of multiple power sources plus very high transmission power that may interfere with medical/communication devices. The laser provides a single universal device to communicate with dozens, hundreds, or even thousands of independent targets at ranges of one foot to 5000+ meters. Speed of training and cost efficiencies are obtained by providing training at a rate two to three times faster than the previous art. No downrange travel time, an important plus when considering disadvantaged shooters, plus each trainee resets his own target immediately and moves to the next target thereby, providing the subsequent shooter immediate access to a fresh target will display the time/cost advantages. Previous laser-related art used a sensor to record or display a shot's placement, not activate an electro-mechanical device to advance a fresh target into position. The drive apparatus can be modified, with the addition of a gear and chain, to reset or activate steel or other reactive targets. Current U.S. Army marksmanship training sites utilizes such reactive steel targets on bases across the country.

### BRIEF DESCRIPTION OF THE SEVERAL VIEWS OF THE DRAWING

FIG. 1 Present invention front view perspective.

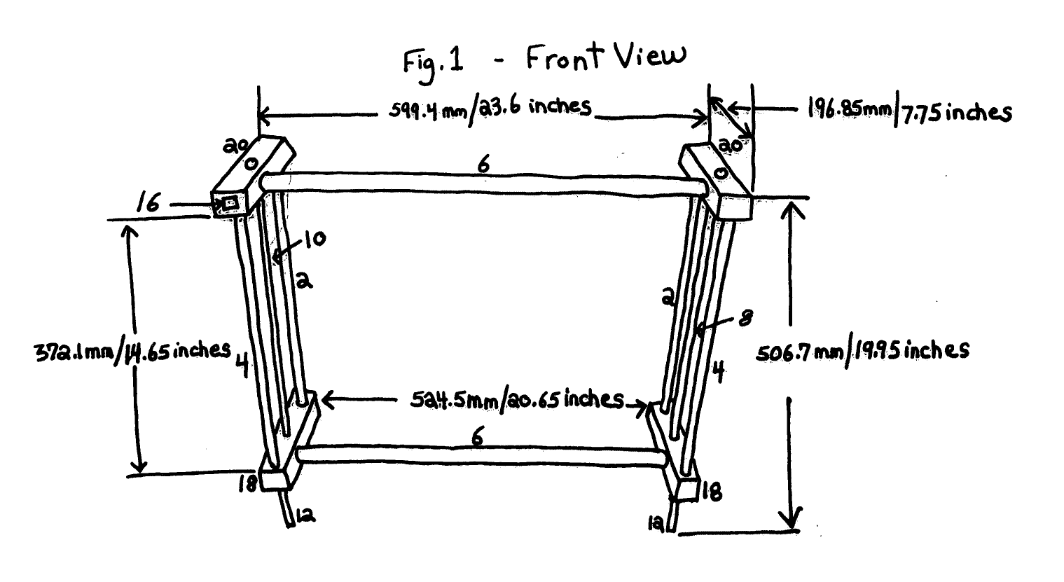

FIG. 2 Left angle front view of FIG. 1.

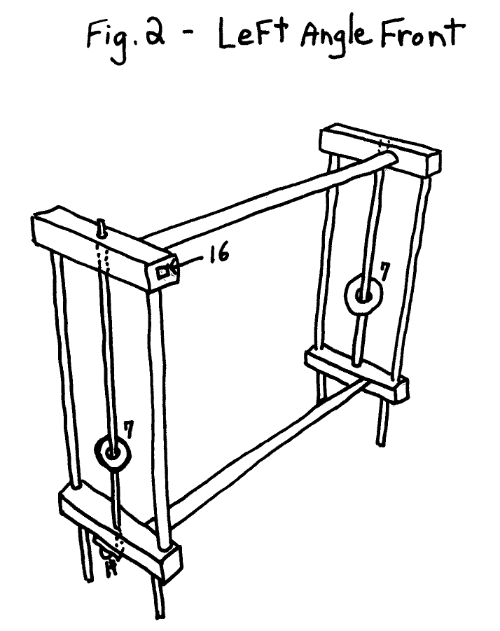

FIG. 3 View of FIG. 1 from the right side.

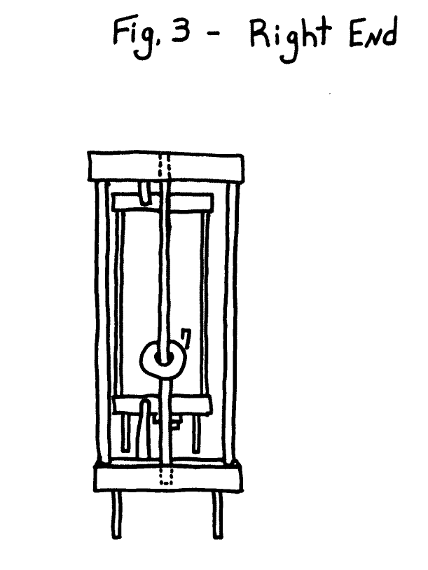

FIG. 4 View of FIG. 1 from the left side.

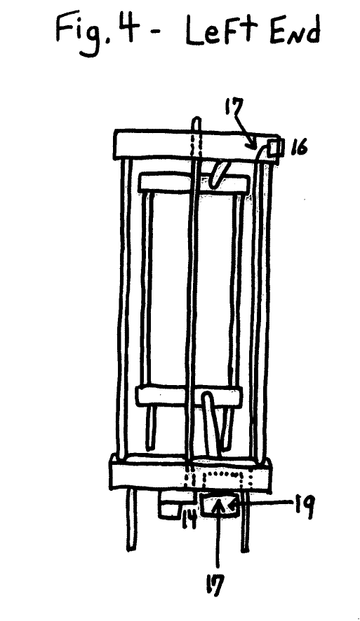

FIG. 5 A cut-away view of FIG. 4 showing the motor and gearset, drive extension from gearset, light activated relay and switch, battery holder, light activated relay and switch cover plate and mounting plate for battery holder and power switch.

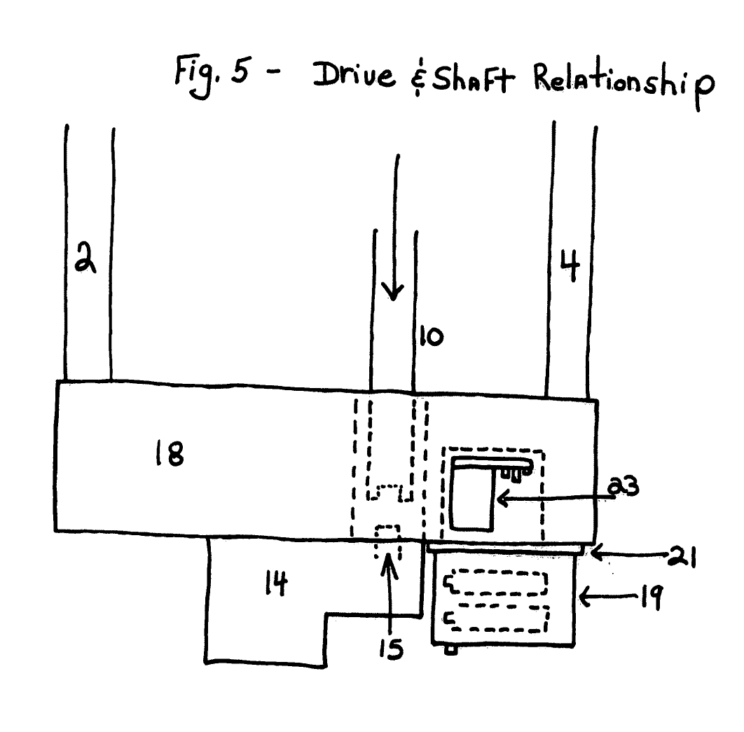

FIG. 6 Right angle front perspective of complete apparatus.

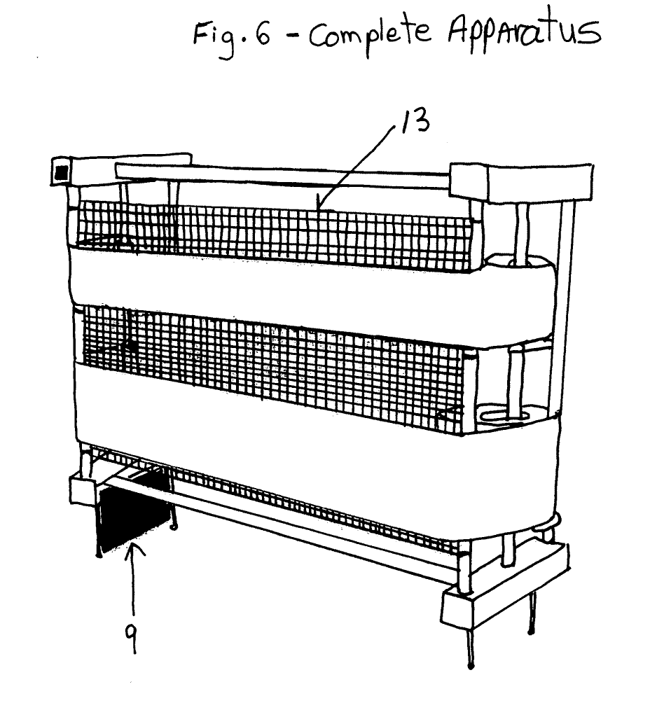

FIG. 7 Close-up view of the supportive backing material.

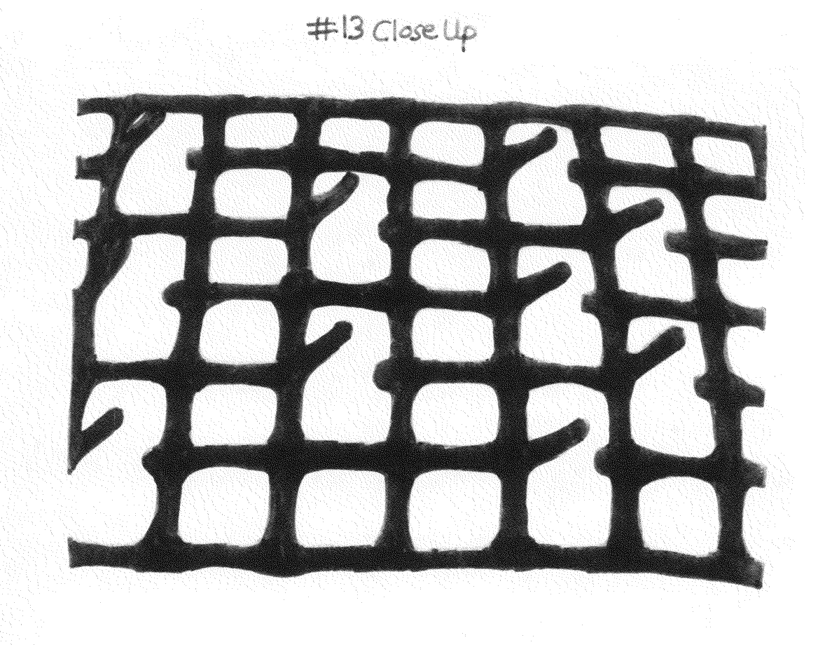

FIG. 8 Detail of the Relay, switch, Battery, and Motor Relationship

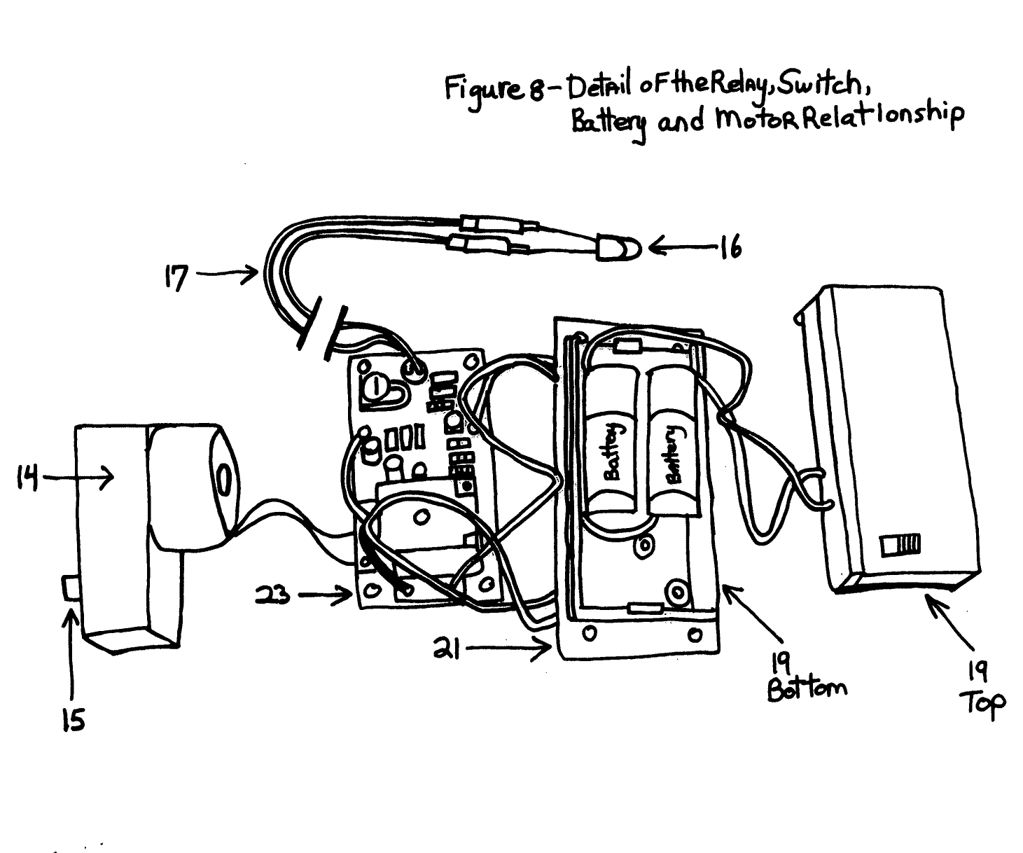

### DETAILED DESCRIPTION OF THE INVENTION

The present invention relates to Target Apparatus utilizing laser light actuated target advancement with backing allowing targets of recycled roll paper.

The device is comprised of the following:

Reference Number and Name of Part:

1—Target Apparatus

2—Horizontal Upper Support

3—Tension Band for Target Rolls

4—Vertical Front Supports and Target Material Axis Points

5—Target Material Roll

6—Horizontal Lower Support

7—Adjustable Support for Rolls of Target Material

8—Target Roll Supply Shaft

9—Debris Shield

10—Target Roll Take-Up and Drive Shaft

12—Target Apparatus Riser

13—Target Backing Material

14—Motor and Gearset

15—Drive Extension from Gearset

16—Light Activated Relay and Switch Sensor

17—Wiring from Light Activated Relay and Switch Sensor to the Light Activated Relay and Switch

18—Lower Stand Base Support

19—Battery Holder, Batteries, and Light Activated Relay and Switch Power Switch

20—Upper Stand Shaft Support

21—Light Activated Relay and Switch Cover Plate that also serves as the Mounting Plate for the Battery Holder and Light Activated Relay and Switch Power Switch

22—Light Activated Relay and Switch

*1—The Target Apparatus 1 is configured and designed to allow a shooter to shoot and advance targets without removing the firearm from its' shooting position in the shooters hands or in relationship to the target. The Target Apparatus may comprise any hard, durable material known in the art, including but not limited to wood, metal, and plastic. It is sized to accommodate shooting competition standards.

*2—The Vertical Rear Supports are supports configured to support and stabilize the upper and Lower Stand Base Support 18 and the Upper Stand Shaft Support 20. They are preferably shaped as long, cylinders having a circular cross section, but could take any other shape, such as rods having an oval, rectangle, or hexagonal cross section comprised of any hard, durable material known in the art, including but not limited to wood, metal, and plastic.

*3—Tension Bands for Target Rolls are designed to keep pressure on the supply rolls to prevent projectile impact or wind from stripping excess target material from the supply roll and causing the material across the front of the shooting section of the apparatus to sag. The are preferably elastic bands but may be comprised of other materials like plastic with elastic bands or springs attached to their ends.

*4—Vertical Front Supports and Target Material Axis Points are supports for the upper and Lower Stand Base Support 18 and the Upper Stand Shaft Support 20. The Supports also acts as the axis points for the target material leaving the Target Roll Supply Shaft 8 and turning to cross the shooting area and being taken up on the Target Roll Take-Up Drive Shaft 10. They are preferably shaped as long, cylinders having a circular cross section, but could take any other shape, such as rods having an oval, rectangle, or hexagonal cross section comprised of any hard, durable material known in the art, including but not limited to wood, metal, and plastic.

*5—Target Material Roll comprise any suitable material that indicates where a projectile penetrated its' surface. Target Roll Materials can be, but are not limited to, adding machine paper, sections of gift-wrapping paper, craft paper rolls, rolls of paper used for disposable table cloths, and paper towels.

*6—Horizontal Upper and Lower Supports connect the left and right Lower Stand Base Supports 18 and the left and right Upper Stand Shaft Supports 20. They are preferably shaped as long, cylinders having a circular cross section, but could take any other shape, such as rods having an oval, rectangle, or hexagonal cross section comprised of any hard, durable material known in the art, including but not limited to wood, metal, and plastic.

*7—Adjustable Support for Rolls of Target Material holds supply and take-up Target material rolls in place so they cross the shooting area at the same level. They are preferably flat circular discs comprised of any hard, durable material known in the art, including but not limited to wood, metal, and plastic.

*8—Target Roll Supply Shaft holds the supply of unused Target Material Rolls 5 in place until Target Material is drawn across the shooting area by the Motor and Gearset 14. The Target Roll Supply Shaft is preferably shaped as a long, cylinder having a circular cross section, but could take any other shape, such as a rod having an oval, rectangle, or hexagonal cross section comprised of any hard, durable material known in the art, including but not limited to wood, metal, and plastic.

*9—Debris Shield is mounted on the inside of the left Lower Stand Base Support 18 and protects the Motor and Gearset 14 from impact of debris should a projectile land short of the Target Apparatus 1 and scatter debris. It is preferably, but not limited to, a rectangular shape extending below the bottom of the Motor, Gearset 14 and comprised of any hard, durable material known in the art, including but not limited to wood, metal, and plastic.

*10—Target Roll Take-Up and Drive Shaft draws Target Material from the Target Material Roll 5 that is stored on the Target Roll Supply Shaft 8 and collects it after the Target Material has been drawn through the shooting area. The bottom of the shaft has a hollow that is keyed to the Drive Extension from the Gearset 15. The shaft is preferably shaped as a long, cylinder having a circular cross section, but could take any other shape, such as a rod having an oval, rectangle, or hexagonal cross section comprised of any hard, durable material known in the art, including but not limited to wood, metal, and plastic.

*12—Target Apparatus Risers support the Target Apparatus 1 above the material upon which it is set. A minimum height is required to keep the Motor and Gearset 14 above the material upon which the Target Apparatus 1 is set. There is not maximum height for these risers. They are preferably shaped as cylinders having a circular cross section, but could take any other shape, such as rods having an oval, rectangle, or hexagonal cross section comprised of any hard, durable material known in the art, including but not limited to wood, metal, and plastic.

*13—Target Backing Material supports the Target Material as it is drawn across the shooting area. This backing prevents the Target Material from twisting or moving in the wind or when impacted by a projectile and allows very inexpensive Target Materials to be used. Extensions, from the surface of the Target Backing Material are angled toward the Target Roll Take-Up and Drive Shaft. They are spaced and angled so as to prevent torn segments of Target Material from snagging in the Target Backing. If segments of Target Material extend into the Target Backing Material, the Motor and Gearset 14 will draw the segments up the angled raised extensions and out of the Target Backing Material. The Target Material can then proceed to be collected on the Target Roll Take-Up and Drive Shaft 10. The Target Backing Material is comprised of any flexible, durable material known in the art, including but not limited to plastic, nylon, or other synthetics.

*14—Motor and Gearset provide the power to draw the Target Material from the Target Material Roll 5 that is stored on the Target Roll Supply Shaft 8 and move it across the shooting area to be collected on the Target Roll Take-Up and Drive Shaft 10. The Battery Holder and Light Activated Relay and Switch Power Switch 19 contains the batteries to power the Motor and Gearset 14 are comprised of, but not limited to Direct Current power since Alternating Current with or without the use of batteries and converters can also be utilized, as well as, Spring Tension Drive Mechanisms used in place of the Motor to drive the Target Roll Take-Up and Drive Shaft 10.

*15—Drive Extension from the Gearset engages the hollow located in the bottom of the Target Roll Take-Up and Drive Shaft. The extenstion is preferably rectangular in shape, but could take any other shape, such as Semi-circular, or hexagonal in cross section comprised of any hard, durable material known in the art, including but not limited to wood, metal, and plastic.

*16—Light Activated Relay and Switch Sensor. Can be located in any support on the apparatus or it may be located remotely off of the target system.

*17—Wiring from Light Activated Relay and Switch Sensor to the Light activated Relay and Switch allows remote activation of the Target Apparatus. The light projected from the shooting position activates the Relay and Switch which then completes the power circuit to engage the Batteries, Motor and Gearset. The Circuits are comprised of but not limited to Normally Opened and Normally Closed.

*18—Lower Stand Base Support provides mounting and support for the lower portion of the Target Apparatus 1. The Left Lower Stand Base Support provides attachment for the Vertical Rear Support 2, the Left Vertical Front Support and Target Material Axis Point 4, the Horizontal Lower Support 6, the Debris Shield 9, the Motor and Gearset 14, the Target Apparatus Riser 12, and provides the access for the Target Roll Take-Up and Drive Shaft 10 to pass through and engage the Drive Extension from the Gearset 15. The Left Lower Stand also has a cavity holding the Light Activated Relay and Switch 23. The Light Activated Relay and Switch Cover Plate 21 covers the Light Activated Relay and Switch 23 and also serves as the Mounting plate for the Battery Holder and Light Activated Relay and Switch Power 19. The Right Lower Stand Base Support provides mounting and support for the lower portion of the Target Apparatus 1. The Right Lower Stand Base Support provides attachment for the Vertical Rear Support 2, the Right Vertical Front Support and Target Material Axis Point 4, the Horizontal Lower Support 6, and the Target Apparatus Riser 12. The Lower Stand Base Support is preferably rectangular in shape, but could take any other shape, such as, but not limited to, Circular, Semi-circular, Oval or Hexagonal in cross section comprised of any hard, durable material known in the art, including but not limited to wood, metal, and plastic.

*19—The Battery Holder, Batteries, and Light Activated Relay and Switch Power Switch 19 contains both the battery to power the Light Activated Relay and Switch 23 but also another battery that is attached to the entry side of the Relay. This battery releases it's current when the Light Activated Circuit is completed once the Light Activated Relay and Switch Sensor 16 is engaged by a laser or similar light source. This current activates the Motor and Gearset 14.

*20—The Upper Stand Shaft Supports provide Support and Attachment for the Upper Portion of the Target Apparatus 1. The following are attached to the Upper Stand Shaft Support: the Vertical Rear Support 2, the Vertical Front Support and Target Material Axis Point 4, the Horizontal Upper Support 6, and the Light Activated Relay and Switch Sensor 16. The Upper Stand Shaft Supports also provide pass-through support for the Target Roll Take-Up and Drive Shaft 10 and the Target Roll Supply Shaft 8. The Upper Stand Base Support is preferably rectangular in shape, but could take any other shape, such as, but not limited to, Circular, Semi-circular, Oval or Hexagonal in cross section comprised of any hard, durable material known in the art, including but not limited to wood, metal, and plastic.

*21—Light Activated Relay and Switch Cover Plate also serves as a mounting plate for the Battery Holder and Light Activated Relay and Switch Power Switch 19 that holds the two battery cells. The Power Switch engages the Light Activated Relay and Switch. This switch is necessary to prevent the Light Activated Relay from drawing constant power from the battery thereby shortening the battery's life.

22—Light Activated Relay and Switch Cover Plate that also serves as the Mounting Plate for the Battery Holder and Light Activated Relay and Switch Power Switch.

23—Light Activated Relay and Switch

All listed elements are necessary for the invention to work. Optional elements would be related to size only.

The Supports 2,4,6 are connected to Base Supports 18 & 20. Any connections described in this application may include any known connectors, including screws, bolts, adhesives, etc. Target Roll Take-Up Drive Shaft 10 passes through 20 Left and proceeds down through 18 Left and an indent in the bottom of 10 engages the drive extension 15 of 14. Target Roll Supply Shaft 8 passes through 20 Right and rests in a socket in 18 Right. Target Material Rolls 5 are placed in position while 8 is being positioned. The Motor and Gearset 14 is mounted under 18 Left so the drive key aligns in the center of the hole in the base of 18 Left. The Light Activated Relay and Switch Sensor 16 is mounted on the front of 20 Left. Wiring 17 runs from the rear of 16 down behind 4 Left, through 18 Left and connects to the Light Activated Relay and Switch 23. Target Backing Support Material 13 is mounted between 4 Left and 4 Right. Target Material Rolls 5 rest upon this Support Material on their path across the shooting area. When target material is torn from projectile impact (projectiles comprise but are not limited to bullets, pellets, BBs, bolts and arrows) and extends into the backing material, the drive motor will free the torn material due to the angle of alternating 45 degree extensions protruding from the surface of the backing material.

The shooter shines his laser sight, or other chosen light source, on the Light Activated Relay and Switch Sensor 16 which activates the Light Activated Relay and Switch 23. The normally open circuit is then closed completing the circuit between the battery and drive motor. The motor's drive extension 15 that extends up into the recessed indent of the Target roll Take-up Drive Shaft 10 causes the shaft to rotate and begin drawing Target Roll Material 5 from the Target Roll Supply Shaft 8 causing it to cross the shooting area and eventually be collected on the Target Roll Take-Up Drive Shaft 10.

To make this invention, one could first provide the elements listed. Then, these elements could be connected using screws, bolts, and adhesives to produce the Target Apparatus 1 as shown in the drawing.

This invention could be configured to be very tall when compared to it's width. For example, the shooting area could be 4 feet tall and only 2 feet wide. Different shooting sports will require different configurations.

A shooter would first place the Target Material Roll 5 on the Target Roll supply shaft 8. The Target material would then be drawn from the supply roll, out and around the Fixed Support & Target Roll Axis, across the Target Backing Support Material, around the receiving Fixed Support & Target Roll Axis and onto the Target Roll Take-Up Drive Shaft 10. The target material is affixed to the Target Roll Take-Up Drive Shaft with a tape-like adhesive strip. After engaging the current target, the firearm or bow's laser sight is activated and illuminates the Light Activated Relay and Switch Sensor 16 which, in turn, activates the Light Activated Relay and Switch 23. The Relay located on the Light Activated Relay and Switch 23 then releases current to the Drive motor and the Target Roll Take-Up Drive Shaft and a new target is drawn from the Target Roll Supply Shaft and the shooter has not left the shooting position or had to re-handle their firearm or bow.

Any material may be drawn from a supply spool with this remote light-activated relay and switch 23. For example, banners could be rolled and unrolled on auditorium ceilings without the danger of climbing to great heights to engage a power switch. The complete laser activated mechanism may be configured in the Lower Stand Base Support 18 in such a way as to reset a reactive target comprised of any hard, durable material known in the art, including but not limited to wood, metal, and plastic back into a set position after a projectile has achieved impact. Current US Army Marksmanship Training uses such reactive targets.

Current solutions require twice the firearm handling. The proposed system does not require removing the firearm from shooting position. The current solution creates twice the opportunity for handling errors and movement of the muzzle off the target line into unsafe positions.

What is claimed is:

1. A target apparatus for remotely presenting paper targets for firearm, airgun, or archery practice comprising: a frame to support a vertical supply shaft and a vertical collection shaft; a roll of paper material with printed targets; a support material as a target backing attached horizontally between the said vertical supply shaft and the said vertical collection shaft; a geared motor mounted on the said frame to receive electrical current provided by wiring to a battery; a drive extension from the said geared motor to engage an indentation in the bottom of the said vertical collection shaft; tension bands to prevent premature release of said paper material with printed targets from said vertical supply shaft; a debris shield to prevent impact of projectile-powered debris into the said geared motor.

2. The target apparatus as defined in claim 1 further including a laser sensitive sensor mounted in the said frame; a wire attaching the said laser sensitive sensor to a laser-activated circuit board; a battery-powered relay mounted on the said laser-activated circuit board; a switched battery holder; a battery to power the said laser-activated circuit board and said battery powered relay; a second battery connected to the input side of the said battery powered relay; wiring to transport the current of the said battery-powered relay to the said geared motor to drive the said vertical collection shaft once the said battery-powered relay is energized.

3. The target apparatus as defined in claim 1 having a target area between the top, bottom, left, and right sides of said frame; and risers attached to the bottom of the said frame.
